(19) United States
(12) Patent Application Publication
(10) Pub. No.: US 2025/0180092 A1
(43) Pub. Date: Jun. 5, 2025

(54) PASSIVE RESETTABLE STIFFNESS DAMPER

(71) Applicant: Ohio University, Athens, OH (US)

(72) Inventor: Kenneth K. Walsh, Athens, OH (US)

(21) Appl. No.: 19/047,085

(22) Filed: Feb. 6, 2025

Related U.S. Application Data
(63) Continuation of application No. PCT/US23/29688, filed on Aug. 8, 2023.
(60) Provisional application No. 63/396,295, filed on Aug. 9, 2022.

(51) Int. Cl. F16F 9/50

(52) U.S. Cl. CPC F16F 9/50; F16F 2228/066

(57) ABSTRACT

Described and shown are passive resettable stiffness dampers, which are of compact and simplified design, and configured to produce a damping force that varies optimally with vibration-inducing loading.

### TECHNICAL FIELD

Exemplary embodiments of the general inventive concept are directed to a passive resettable stiffness device that can be used, for example, to provide for the effective vibration suppression of objects of interest.

### BACKGROUND

Vibration control technologies are used to protect structures from dynamic loading by dissipating energy that would otherwise be absorbed by the structure. The characteristics of a vibration control technology are dictated by the type of structure and dynamic loading.

In the field of structural engineering, vibration control technologies are employed to protect building and bridge structures from the ground motion caused by earthquakes. These vibration control technologies, often referred to as dampers, come in many different forms depending on their energy dissipation mechanism and power requirements. The most reliable type of damper is the passive damper, which produces forces in direct response to the structure motion without any external power requirement. Passive dampers include, but are not limited to, viscous dampers, viscoelastic dampers, friction dampers, and metallic yielding dampers.

### SUMMARY

Exemplary embodiments of the general inventive concept present passive resettable stiffness damper (PRSD) devices that include the aforementioned desirable characteristics.

Exemplary PRSD device embodiments include a cylinder, such as without limitation, a pneumatic or hydraulic cylinder, having a reciprocating piston and one or a pair of associated projecting piston rods. A resetting mechanism is mounted to or otherwise associated with the cylinder. The resetting mechanism includes a mechanically operated toggle valve with a spring return, as well as a series of discs that are coupled to corresponding shafts to form a gear train. The disc and shaft assemblies of the gear train can rotate, but are constrained from translation.

The toggle valve of the resetting mechanism is located in a bypass loop that connects the cylinder volumes on either side of the piston and operates to regulate fluid flow therebetween. The toggle valve is open or closed depending on the position of a toggle that is coupled to the valve.

The resetting mechanism is positioned relative to the cylinder such that a first disc of the gear train is in contact with the piston rod of the cylinder and another disc of the gear train is in contact with the toggle of the toggle valve. As such, an extension or retraction of the piston rod of the cylinder in response to vibration forces will produce a rotation of the first disc, which in turn will produce a rotation of the disc in contact with the toggle of the toggle valve. Rotation of the disc in contact with the toggle of the toggle valve causes a resulting displacement of the toggle, which actuates the toggle valve. Through this process, the valve is opened and closed each time the piston changes direction, thereby producing a resetting of the damper force produced by the PRSD.

Other aspects and features of the inventive concept will become apparent to those skilled in the art upon review of the following detailed description of exemplary embodiments along with the accompanying drawing figures.

### BRIEF DESCRIPTION OF THE DRAWINGS

In the following descriptions of the drawings and exemplary embodiments, like reference numerals across the several views refer to identical or equivalent features, and:

FIG. 1 is an isometric view of one exemplary embodiment of a single-sided passive resettable stiffness damper (PRSD) according to the inventive concept;

FIG. 2 is a top view of the exemplary single-sided PRSD of FIG. 1;

FIG. 3 is a side view of the exemplary single-sided PRSD of FIG. 1;

FIG. 4 is an end view of the exemplary single-sided PRSD of FIG. 1;

FIG. 5 is an opposite end view of the exemplary single-sided PRSD of FIG. 1;

FIG. 6 is an isometric section view of the exemplary single-sided PRSD of FIG. 1;

FIG. 7 is an exploded view of the exemplary single-sided PRSD of FIG. 1;

FIG. 8 is an enlarged view of one portion of the exemplary single-sided PRSD of FIG. 1;

FIGS. 9A-9C illustrate various positions of a resetting mechanism toggle of the exemplary single-sided PRSD of FIG. 1;

FIGS. 10A-10B are enlarged views of the resetting mechanism toggle shown in FIGS. 9A-9C;

FIG. 11 is an isometric view of one exemplary embodiment of a double-sided passive resettable stiffness damper (PRSD) according to the inventive concept;

FIG. 12 is a top view of the exemplary double-sided PRSD of FIG. 11;

FIG. 13 is a side view of the exemplary double-sided PRSD of FIG. 11;

FIG. 14 is an enlarged end view of the exemplary double-sided PRSD of FIG. 11;

FIG. 15 is an enlarged opposite end view of the exemplary double-sided PRSD of FIG. 11;

FIG. 16 is an isometric section view of the exemplary double-sided PRSD of FIG. 11;

FIG. 17 is an exploded view of the exemplary double-sided PRSD of FIG. 11;

FIG. 18 graphically illustrates damper force versus piston displacement for one exemplary embodiment of a single-sided closed loop PRSD according to the inventive concept;

FIG. 19 graphically illustrates damper force versus piston displacement for one exemplary embodiment of a single-sided open loop PRSD according to the inventive concept;

FIG. 20 graphically illustrates damper force versus piston displacement for one exemplary embodiment of a double-sided closed loop PRSD according to the inventive concept; and

FIG. 21 graphically illustrates damper force versus piston displacement for one exemplary embodiment of a double-sided open loop PRSD according to the inventive concept.

### DETAILED DESCRIPTION OF THE EXEMPLARY EMBODIMENTS

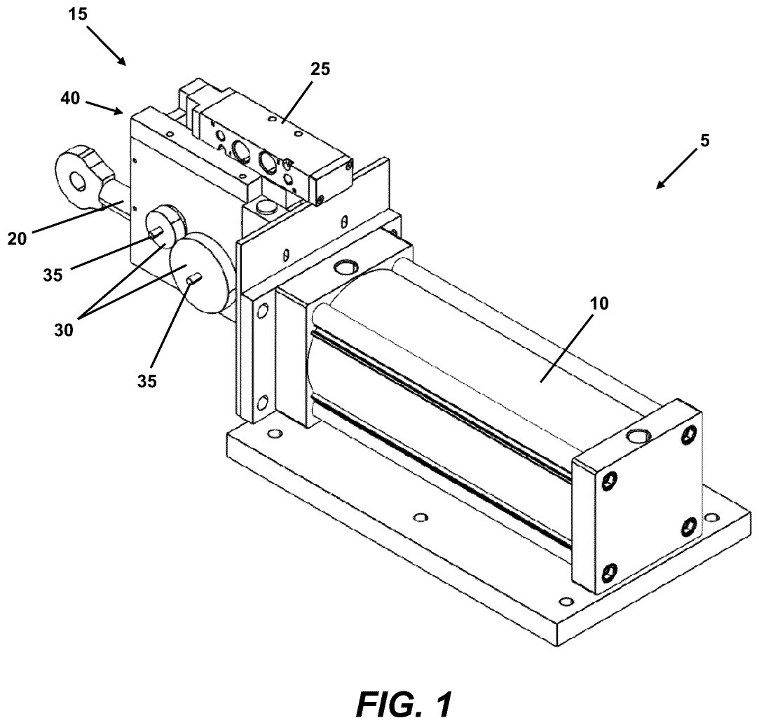

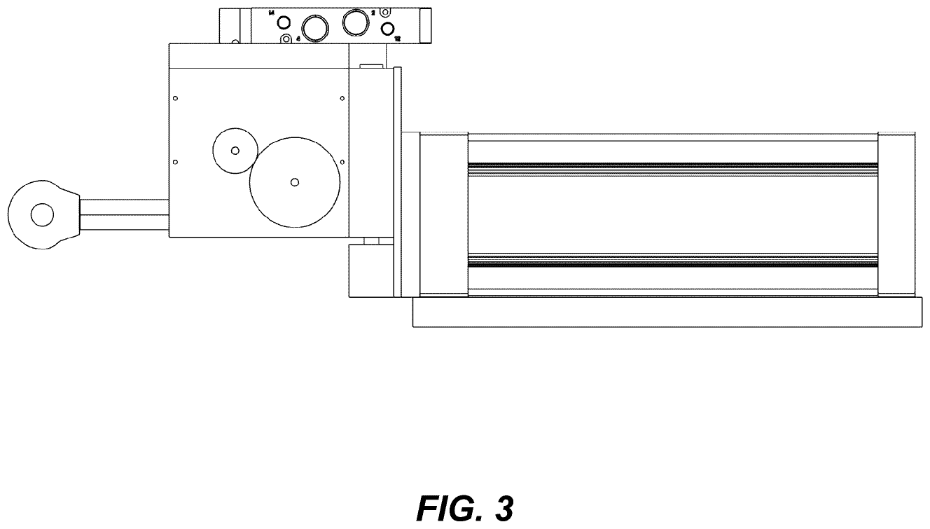

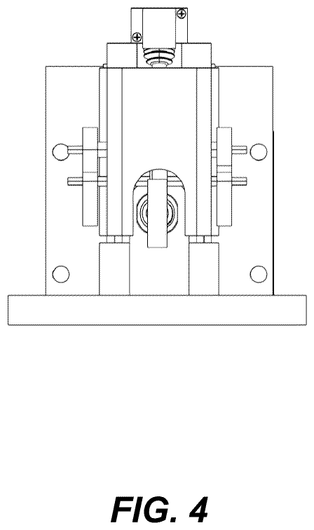

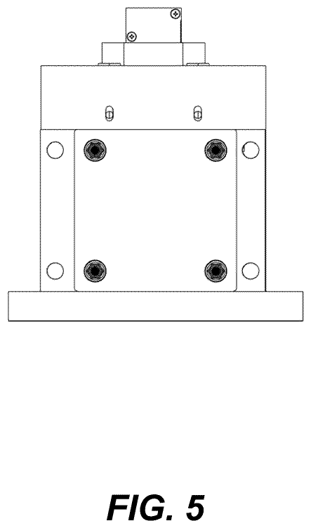

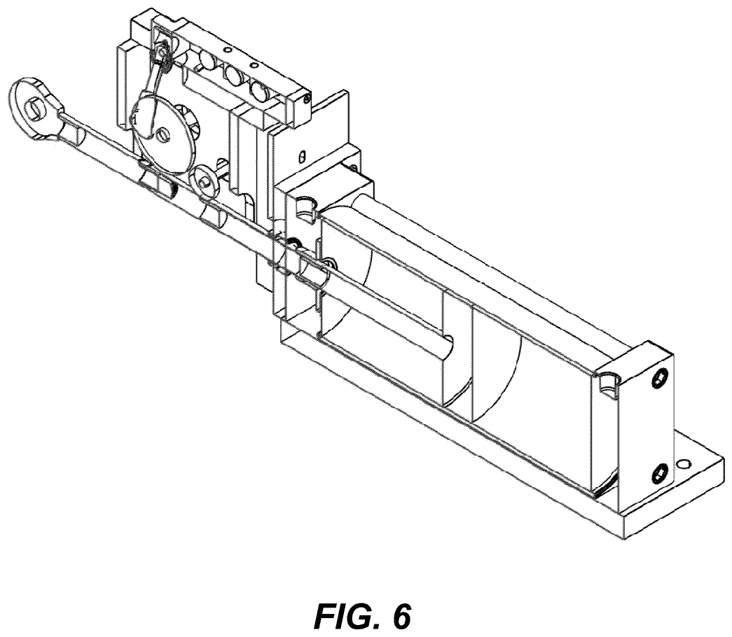

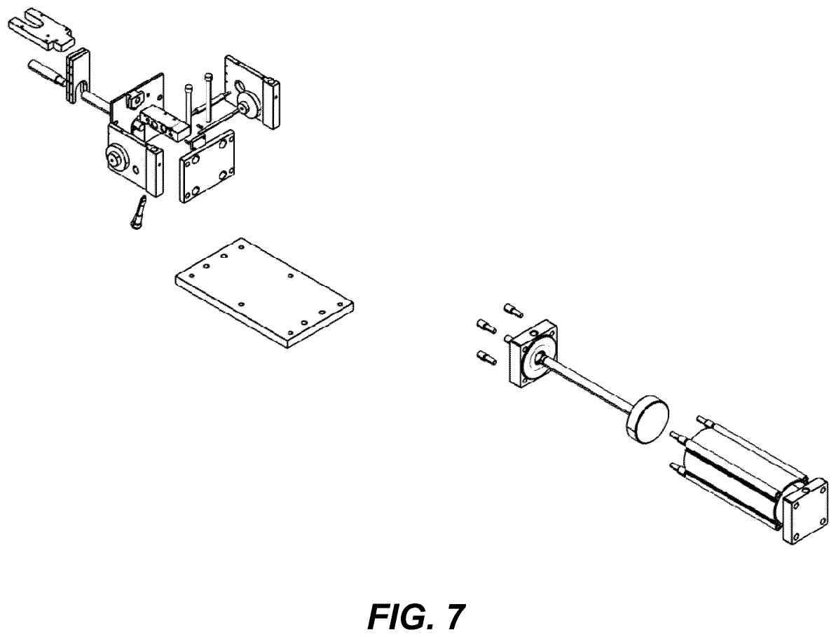

One exemplary embodiment of a single-sided passive resettable stiffness damper (PRSD) 5 is shown in FIGS. 1-7. As used herein, the term “single-sided” is intended to indicate only that a cylinder component of the PRSD has a single piston rod, which extends or retracts from one end of the cylinder.

As shown, the exemplary PRSD 5 include a piston-containing cylinder 10 such as, without limitation, a pneumatic or hydraulic cylinder. A resetting mechanism 15 is mounted to or otherwise associated with the cylinder so as to extend out over the projecting piston rod 20 of the cylinder. The resetting mechanism includes a mechanically operated toggle valve 25 with a spring return, as well as a plurality of discs 30. The “discs” may be toothed gears or another form of discs that are connected to shafts 35 and configured to impart rotational motion to one another when placed into contact (e.g., through toothed engagement, friction, etc.) and subjected to a rotational driving force that is applied to at least one disk. The shafts 35 are supported by a preferably rigid frame 40, such that the discs and shafts can rotate but are constrained from translation.

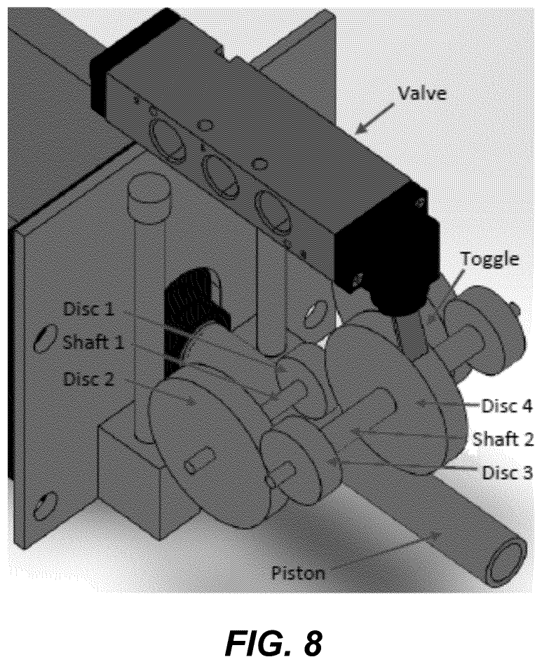

Referring now also to FIG. 8, further details regarding the construction and operation of the resetting mechanism 15 may be observed. As shown, a first disc (Disc 1) is fixed to a first preferably rigid shaft (Shaft 1) between a pair of like second discs (Disc 2), each of which has a diameter that is larger than the diameter of the first disc (Disc 1). The first disc (Disc 1), second discs (Disc 2) and the first shaft (Shaft 1) rotate together and thus have the same angular displacement, rotational velocity, and acceleration. The resetting mechanism 15 is positioned relative to the cylinder 10 such that the first disc (Disc 1) is in contact with the piston rod 20 of the cylinder, which causes the first disc (Disc 1), the second discs (Disc 2) and the first shaft (Shaft 1) to rotate as a unit upon extension or retraction of the piston rod.

A fourth disc (Disk 4) is fixed to a second preferably rigid shaft (Shaft 2) between a pair of like third discs (Disc 3), each of which has a diameter that is smaller than the diameter of the fourth disc (Disc 4). The fourth disc (Disc 4), third discs (Disc 3), and the second shaft (Shaft 2) rotate together and thus have the same angular displacement, rotational velocity, and acceleration. The fourth disc (Disc 4), third discs (Disc 3), and the second shaft (Shaft 2) are caused to collectively rotate upon collective rotation of the first disc (Disc 1), second discs (Disc 2) and the first shaft (Shaft 1), due to engagement of the second discs (Disc 2) on the first shaft (Shaft 1) with the third discs (Disc 3) on the second shaft (Shaft 2).

As shown in FIGS. 1-8, the mechanically operated toggle valve 25 is mounted at a location above the discs 30 and shafts 35 of the resetting mechanism 15. As may be best observed in FIG. 8, the circumferential edge of the larger fourth disc (Disc 4) on the second shaft (Shaft 2) is in contact with the free end of a toggle 45 of the mechanically operated toggle valve 25, but not in contact with the piston rod 20 of the cylinder 10. Rotation of fourth disc (Disc 4) causes a displacement of the toggle 45 that actuates the toggle valve 25.

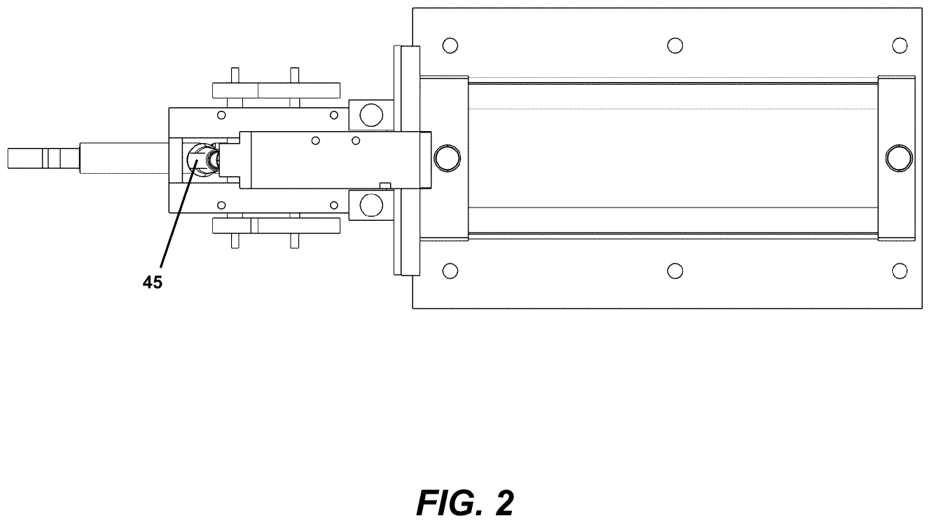

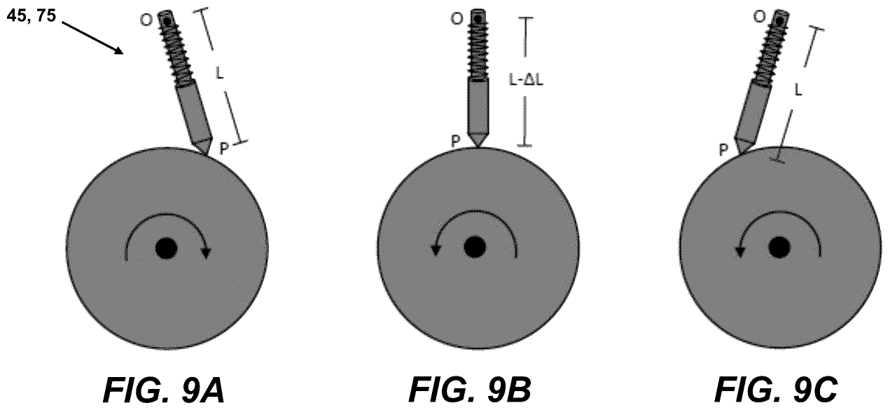

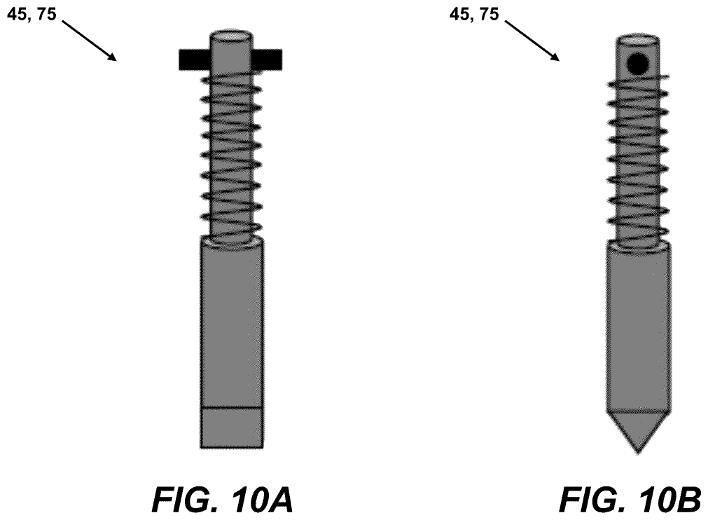

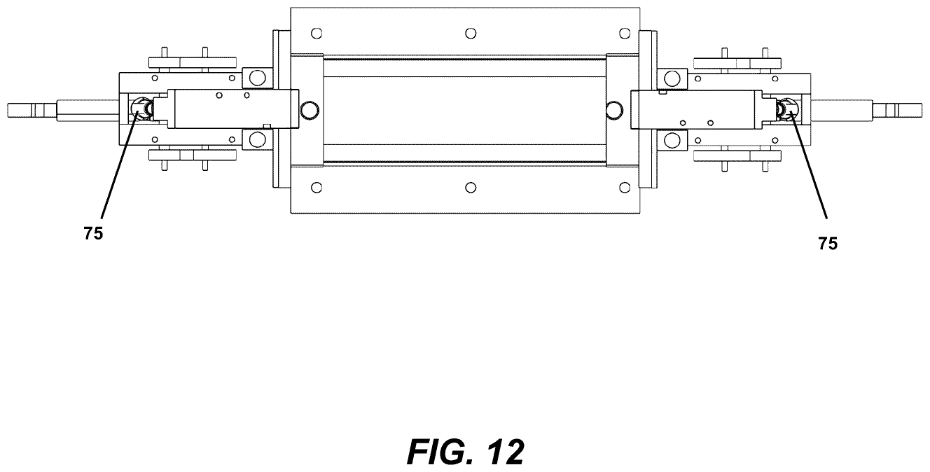

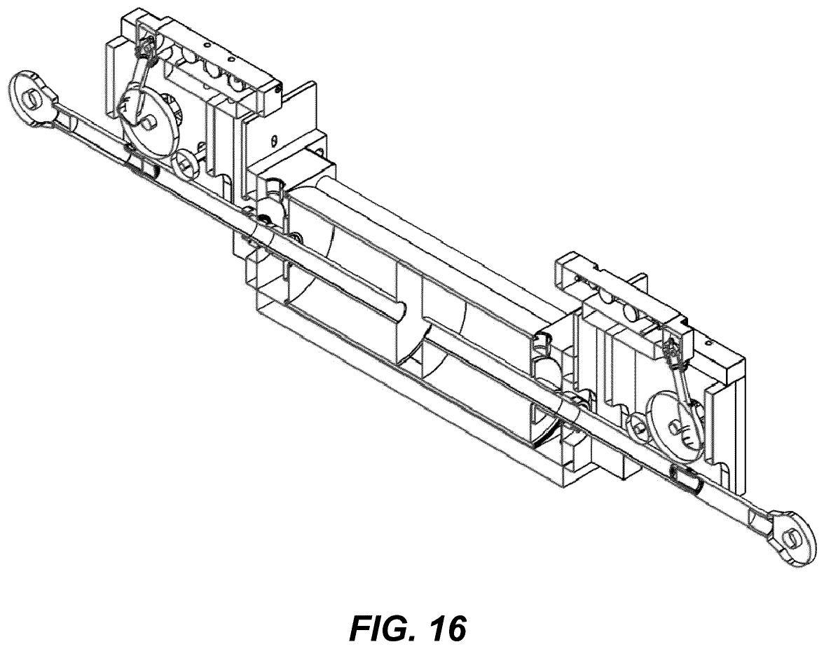

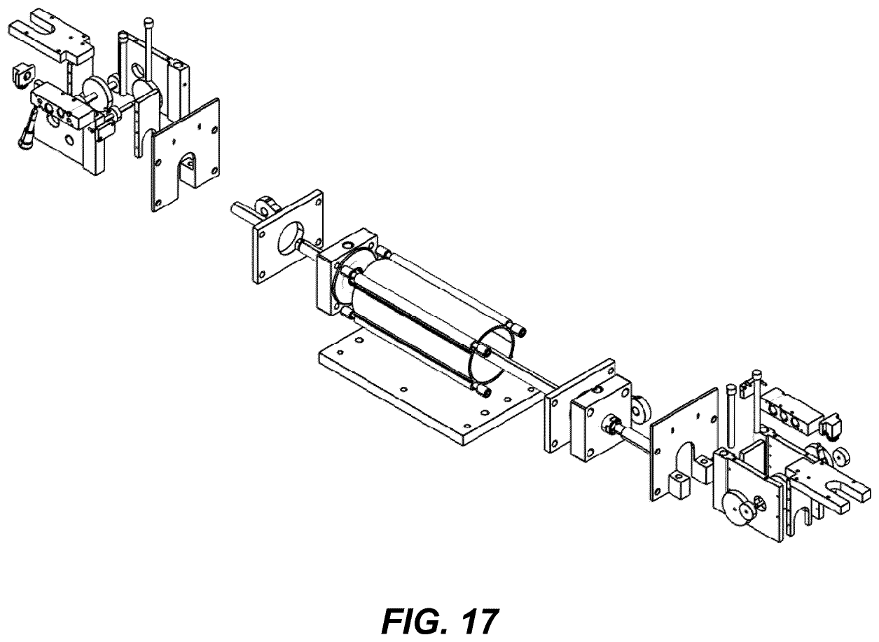

It should be noted that each of the toggle 45 appearing in FIGS. 2, 6 and 7, the toggle appearing in FIG. 8, and the toggle 75 appearing in FIGS. 12, 16 and 17, is depicted only schematically and generically. It is preferred that actual PRSD embodiments according to the inventive concept utilize and operate with a toggle having a reciprocating tip, as represented in FIGS. 9A-9C and 10A-10B and described herein relative thereto.

In this exemplary embodiment of the PRSD 5, the configuration of the discs 30 of the gear train amplifies the displacement of the toggle of the toggle valve 25 relative to displacement of the cylinder piston rod 20 (and piston), such that the displacement of the toggle is greater than the displacement of the piston rod. When further (e.g., large motion) amplification is required, additional discs and shafts can be added between the first shaft (Shaft 1) and the second shaft (Shaft 2) to increase motion amplification while still utilizing discs of relatively small diameter.

The toggle valve 25 of the resetting mechanism is located in a bypass loop (not shown) that connects the cylinder volumes on opposite sides of the piston of the cylinder 10 and regulates fluid flow therebetween. Referring now to FIGS. 9A-9C, it may be better understood that the toggle valve 25 is closed when the toggle 45 is in a right position (FIG. 9A) or a left position (FIG. 9C), and the valve is open when the toggle is in a center position (FIG. 9B), with all of said positions being relative to the view of the resetting mechanism shown in FIG. 8.

With respect to the exemplary PRSD 5 as depicted in FIGS. 1-7, the initial position of the toggle is the right position depicted in FIG. 9A. For a displacement of the cylinder piston rod 20 that causes a counterclockwise rotation (relative to the view of the resetting mechanism 15 presented in FIG. 8) of the first disc (Disc 1) and, via gear train interaction, a resulting clockwise rotation of the fourth disc (Disc 4), the toggle remains in the right position, the toggle valve 25 remains closed, and there is an increase in the damper force.

When the piston rod 20 of the cylinder 10 changes direction, the first disc (Disc 1) will rotate in a clockwise direction, which will cause, via gear train interaction, the fourth disc (Disc 4) to rotate in a counterclockwise direction. Counterclockwise rotation of the fourth disc (Disc 4) initially drives the toggle from the right position of FIG. 9A to the center position indicated in FIG. 9B. During this time, the toggle valve will open and the damper force will drop to zero. As the piston rod 20 continues to move in the same direction, additional counterclockwise rotation of the fourth disc (Disc 4) will drive the toggle from the center position of FIG. 9B to the left position shown in FIG. 9C, at which time the toggle valve 25 will close and damper force will again increase.

With the end of the toggle that is in contact with the fourth disc (Disc 4) now oriented in the left position shown in FIG. 9C, the opening and closing action of the toggle valve 25 is repeated when movement of the piston and piston rod 20 next changes direction and the toggle is moved toward the right position shown in FIG. 9A. Through this process, resetting of the damping force occurs each time the piston changes direction.

As explained above and as indicated in FIGS. 9A-9C, resetting of the damping force in the exemplary PRSD 5 requires the toggle 45 on the mechanically operated toggle valve 25 to change its position relative to the fourth disc (Disc 4). More specifically, the contact point P between the toggle 45 and the fourth disc (Disc 4) moves along the circumference of the fourth disc (Disc 4) as shown. Because this requires a change in length ΔL of the toggle 45, the toggle is preferably configured to include a reciprocating tip or to otherwise permit a length compression of the toggle as represented in FIGS. 9A-9C and 10A-10B. In the case of the toggle 45 represented in FIGS. 9A-9C and 10A-10B, the toggle tip is constructed from a hollow shaft with an inner diameter that is slightly larger than the outer diameter of the toggle shaft, and is retained on the toggle shaft in a sliding (reciprocating) relationship. A pre-compressed spring is mounted over the toggle shaft between the toggle tip and the end of the toggle that is pinned or otherwise pivotably affixed to the toggle valve 25. Thus, as the toggle 45 moves from one side of the fourth disc (Disc 4) to the other, the toggle tip is linearly displaced relative to the length of the toggle shaft to accommodate the required change in toggle length ΔL.

It is noted that use of a toggle valve having a toggle with a reciprocating tip (or similar configuration) has a number of advantages, including without limitation: (1) the energy dissipation capacity of the PRSD is enhanced as the toggle action results in the toggle valve only being open for a short time during resetting; (2) the energy dissipation capacity of the PRSD is enhanced by the toggle valve, which enables a high flow rate with a small spring return force; (3) the resetting mechanism is simplified in comparison to certain resetting semi-passive stiffness dampers (RSPSDs) and resetting passive stiffness dampers (RPSDs) of known design; and (4) the PRSD is more compact as a result of the simplified resetting mechanism.

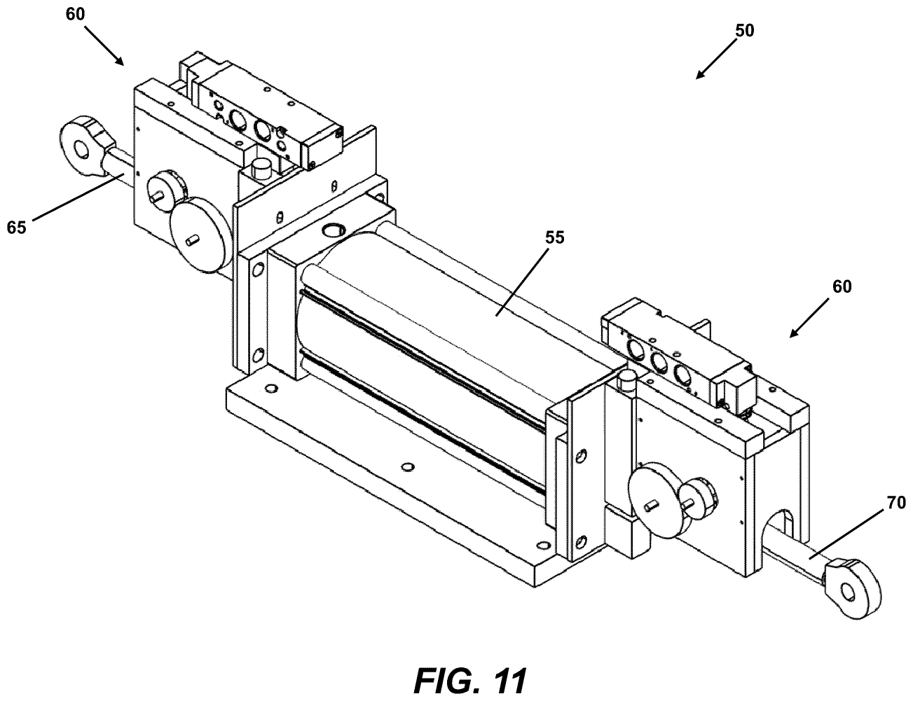

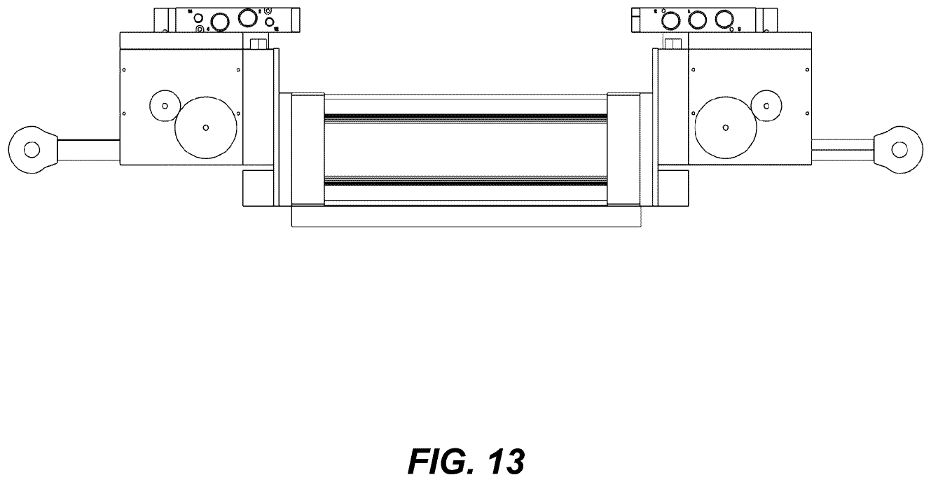

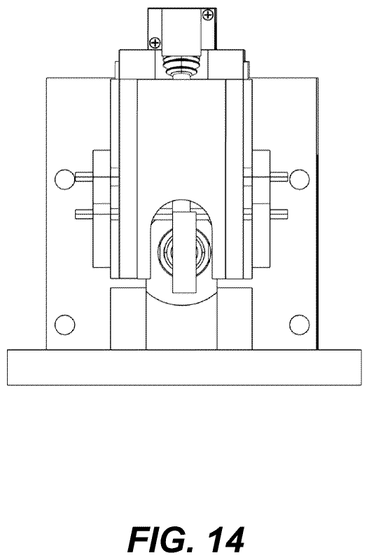

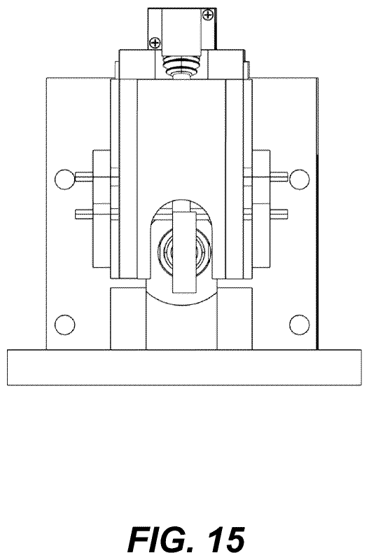

One exemplary embodiment of a double-sided passive resettable stiffness damper (PRSD) 50 is shown in FIGS. 11-17. As used herein, the term “double-sided” is intended to indicate only that a cylinder component of the PRSD has dual piston rods, which extend and retract from opposite ends of the cylinder.

As shown, the exemplary double-sided PRSD 50 again include a piston-containing cylinder 55 such as, without limitation, a pneumatic or hydraulic cylinder. A resetting mechanism 60 is mounted to or otherwise associated with opposite ends of the cylinder that each resetting mechanism 60 extends out over a corresponding piston rod 65, 70 of the cylinder 55.

In this exemplary double-sided PRSD embodiment 50, each resetting mechanism 60 is of the same design, construction and operation as the resetting mechanism 15 employed by the exemplary single-sided PRSD 5. As such, a toggle 75 of each resetting mechanism 60 is again coupled to an associated toggle valve and has a free end in contact with the circumferential edge of a fourth disc (Disc 4) on a second shaft (Shaft 2) of a gear train, as generally depicted in FIG. 8. A further detailed listing of the resetting mechanism 60 components need not be repeated again here. Likewise, the description provided above with respect to resetting mechanism component interaction (and FIG. 8), toggle movement and damper resetting (and FIGS. 9A-9C), and change in length of the toggle of the toggle valve (and FIGS. 10A-10B), applies equally well to the resetting mechanisms 60 of the exemplary double-sided PRSD 50. One difference, of course, is that valve opening and closing and damper resetting occurs as a result of the operation of two resetting mechanisms 60 with respect to the exemplary double-sided PRSD 50, as opposed to a single resetting mechanism 15 with respect to the exemplary single-sided PRSD 5.

One advantage of a double-sided PRSD over a single-sided PRSD, is that the use of two toggle valves with a double-sided PRSD provides for an effective fluid flow rate that is double the flow rate of the single toggle valve of a single-sided PRSD. This higher fluid flow rate increases the speed at which the damper force drops to zero once the valves open during resetting, thereby enhancing the energy dissipation capacity of the PRSD.

In both the single-sided and double-sided exemplary PRSD embodiments shown and described herein, the toggle-valve is in a bypass loop that connects the cylinder volumes on opposite sides of the cylinder piston. Motion of the cylinder piston causes pressure in one side of the cylinder and produces vacuum in the other side. During resetting, the toggle valve opens, the pressure equalizes, and the damper force drops to zero. Such PRSD embodiments may be described as closed-loop systems, because the volume of gas inside the cylinder remains constant.

One advantage of a closed-loop system over an open-loop system is that the gas inside the damper cylinder can be pressurized to increase the damper force. Another advantage of a closed-loop system over an open-loop system is that a closed-loop design can produce approximately twice the damping force as the open-loop design, because the damping force is generated by both the pressure on one side of the cylinder piston and the vacuum on the other side of the cylinder piston. In PRSD embodiments where a pressurized cylinder is employed, cylinder pressure is preferably monitored to detect leaks that might cause a pressure drop on one or both sides of the cylinder and a resulting change in damping characteristics.

In an alternate embodiment of a PRSD, one of the ports on the toggle valve is left open to atmosphere, which results in an open-loop PRSD. In an open-loop PRSD, motion of the cylinder piston causes the cylinder volume on one side of the piston to become pressurized, while the cylinder volume on the other side of the piston remains open to atmospheric pressure. When the piston changes direction, resetting occurs, and the formerly pressurized volume of the cylinder is vented to atmosphere while the cylinder volume that was previously open to atmospheric pressure becomes pressurized.

An advantage of an open-loop system is that a new volume of air is pressurized each time the cylinder piston changes direction. As a result, there is no concern that a PRSD might become overheated during use, and the damping characteristics would remain constant.

In order to validate the inventive concept, prototype PRSDs using air at atmospheric pressure were constructed and tested. Altogether, four PRSDs were tested: (1) a single-sided closed-loop PRSD; (2) a single-sided open-loop PRSD; (3) a double-sided closed-loop PRSD; and (4) a double-sided open-loop PRSD.

During testing, each of the prototype PRSDs was subjected to forty cycles of sinusoidal cylinder piston displacement with an amplitude of 30 mm and frequency of 0.25 Hz. The output force of each of the prototype PRSDs was plotted against piston displacement.

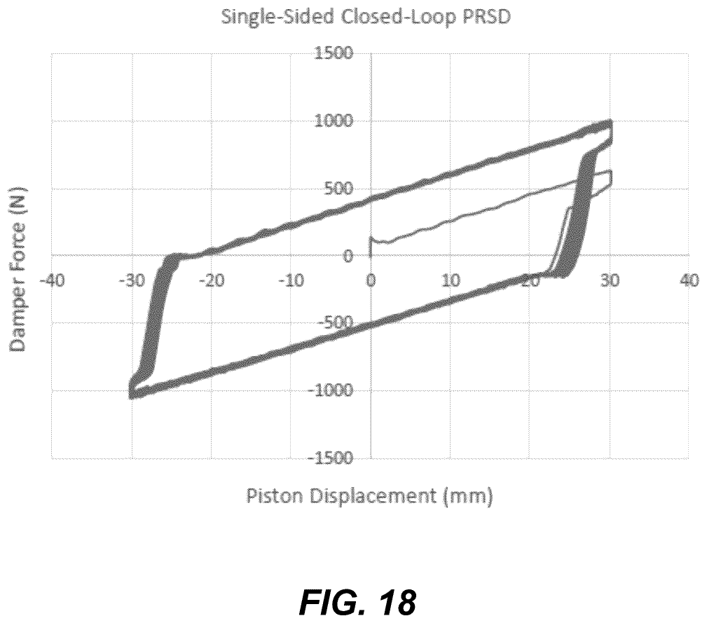

The results of the aforementioned testing are indicated in FIGS. 18-21. As may be observed, the force-displacement loops demonstrate that all of the prototype PRSDs worked as intended, with damper force increasing with increasing piston displacement, and then dropping to zero with each change in piston direction. FIGS. 18-21 further indicate that the force displacement loops for all four of the prototype PRSDs are stable, with very little variation in the force-displacement characteristics over the forty cycles of motion.

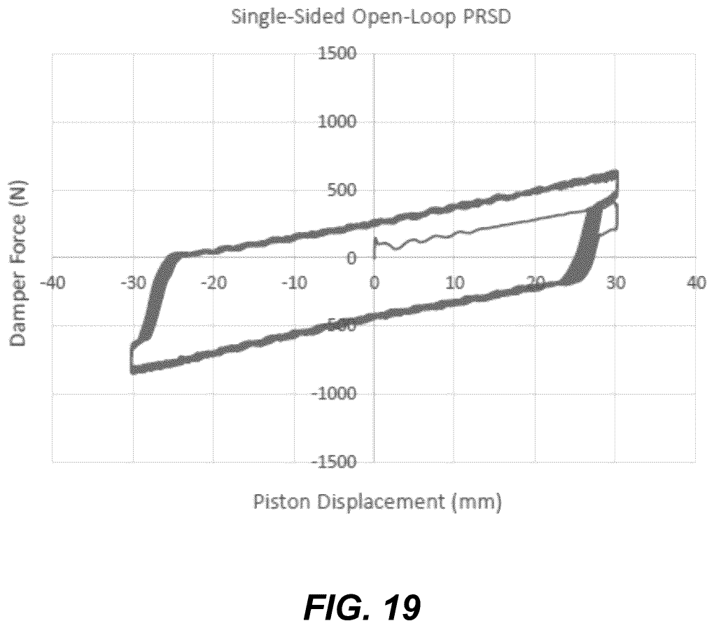

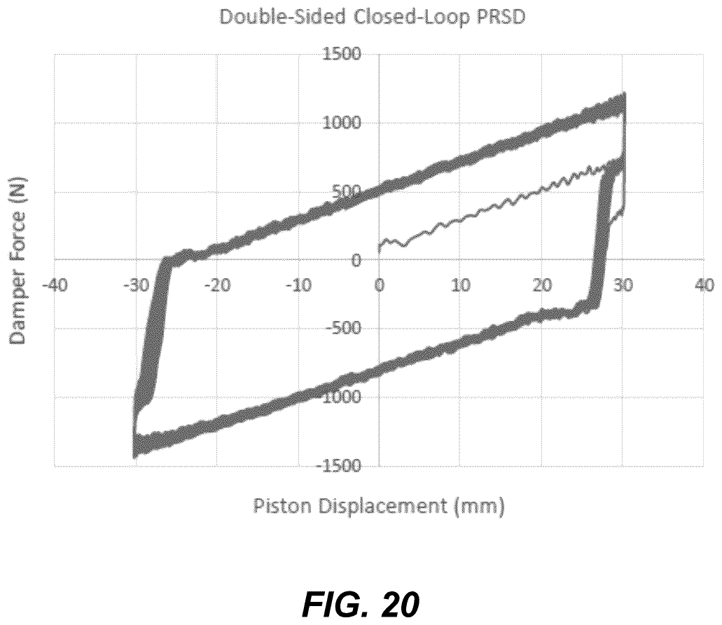

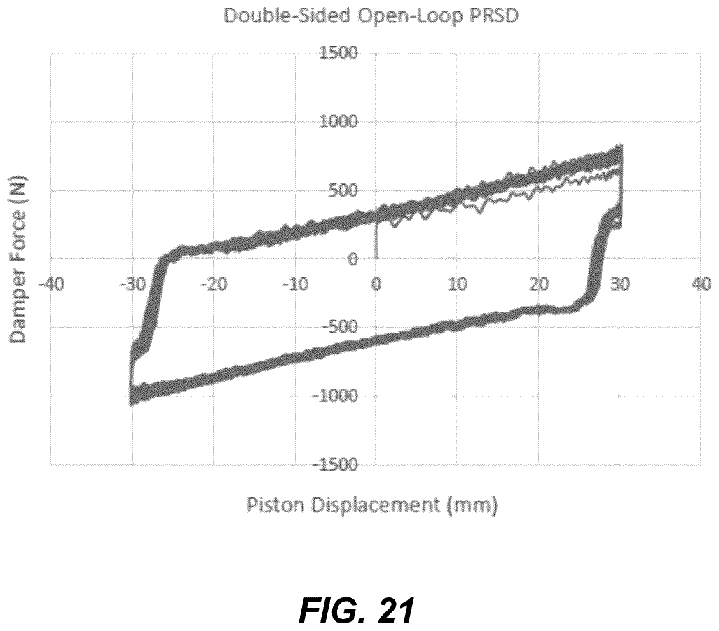

A comparison of FIG. 18 to FIG. 19, and of FIG. 20 to FIG. 21, indicates that the closed-loop PRSD embodiments have a higher effective stiffness than the open-loop PRSD embodiments. This can be attributed to the closed-loop embodiments utilizing the cylinder volumes on both sides of the piston cylinder during operation (one volume under pressurize and the other volume under vacuum), whereas the open-loop embodiments only utilize the cylinder volume on one side of the cylinder piston (under pressure).

Likewise, a comparison of FIG. 18 to FIG. 20 and FIG. 19 to FIG. 21, indicates that the double-sided PRSDs have a higher peak damper force than the single-sided PRSDs. This can be attributed to the double-sided PRSDs having their cylinder pistons extend from both sides of the cylinders, which results in approximately twice the amount of friction between the piston rods and the seals.

While certain exemplary embodiments of the inventive concept are described in detail above, the scope of the general inventive concept is not considered limited by such disclosure, and modifications are possible without departing from the spirit of the general inventive concept as evidenced by the following claims:

What is claimed is:

1. A single-sided passive resettable stiffness damper (PRSD), the PRSD comprising:
a cylinder having a reciprocating piston with an associated piston rod that projects from a first end of the cylinder; and
a resetting mechanism associated with the cylinder and located near the first end thereof, the resetting mechanism comprising:
a mechanically operated toggle valve having a spring return, the toggle valve located in a fluid flow path with the cylinder;
a gear train, the gear train having a plurality of rotatable discs and configured and located such that linear displacement of the piston rod is adapted to cause a rotation of the discs of the gear train, and
a toggle having one end pivotably coupled to the toggle valve, and an opposite free end that is in contact with the gear train;
wherein each change in the direction of rotation of the gear train discs caused by the reciprocating movement of the piston rod in response to vibration forces is adapted to cause the toggle to change the fluid flow path through the toggle valve, thereby resetting the PRSD.

2. The PRSD of claim 1 wherein the cylinder is a pneumatic cylinder.

3. The PRSD of claim 1 wherein the cylinder is a hydraulic cylinder.

4. The PRSD of claim 1 wherein the resetting mechanism is mounted to the first end of the cylinder.

5. The PRSD of claim 1 wherein:
a first disc of the plurality of discs is in contact with the piston rod; and
a second disc of the plurality of discs is in contact with the toggle;
such that the reciprocating movement of the piston rod is adapted to cause a rotation of the first disc, which in turn is adapted to cause a rotation of the second disk, which in turn is adapted to cause a displacement of the toggle, which is adapted to actuate the toggle valve to reset the PRSD.

6. The PRSD of claim 5 wherein the piston rod is adapted to change directions in response to vibration forces such that the PRSD is adapted to be reset each time the piston rod changes direction.

7. The PRSD of claim 5 wherein the first disc and the second disc are in toothed engagement.

8. The PRSD of claim 5 wherein the first disc and the second disc are in frictional engagement.

9. The PRSD of claim 5 wherein the first disc has a smaller diameter than the second disk.

10. The PRSD of claim 9 wherein:
the first disc is fixed to a first shaft between a first pair of disks of the plurality of disks, each of the first pair of disks having a larger diameter than the first disk, such that the first disk and the first pair of disks are adapted to rotate as a unit; and
the second disk is fixed to a second shaft between a second pair of disks of the plurality of disks that are engaged by the first pair of disks, each of the second pair of disks having a smaller diameter than the second disk, such that the second disk and the second pair of disks are adapted to rotate as a unit;
whereby the second disk and the second pair of disks are adapted to be caused to collectively rotate upon collective rotation of the first disk and the first pair of disks.

11. A double-sided passive resettable stiffness damper (PRSD), the PRSD comprising:
a cylinder having a reciprocating piston with a pair of piston rods that project from opposite ends of the cylinder; and
an individual resetting mechanism located near each of the opposite ends of the cylinder and associated with a corresponding one of the piston rods, each of the resetting mechanisms comprising:
a mechanically operated toggle valve having a spring return, the toggle valve located in a fluid flow path with the cylinder;
a gear train, the gear train having a plurality of rotatable discs and configured and located such that linear displacement of the corresponding one of the piston rods is adapted to cause a rotation of the discs of the gear train, and
a toggle having one end pivotably coupled to the toggle valve, and an opposite free end that is in contact with the gear train;
wherein each change in the direction of rotation of the gear train discs of the resetting mechanisms caused by the reciprocating movement of the piston rods in response to vibration forces is adapted to cause the toggles to change the fluid flow path through the toggle valves, thereby resetting the PRSD.

12. The PRSD of claim 11 wherein the cylinder is a pneumatic cylinder.

13. The PRSD of claim 11 wherein the cylinder is a hydraulic cylinder.

14. The PRSD of claim 11 wherein each resetting mechanism is mounted to a respective end of the cylinder.

15. The PRSD of claim 11 wherein, with respect to each resetting mechanism:
a first disc of the plurality of discs is in contact with the corresponding piston rod; and
a second disc of the plurality of discs is in contact with the toggle;
such that the reciprocating movement of the corresponding piston rod is adapted to cause a rotation of the first disc, which in turn is adapted to cause a rotation of the second disk, which in turn is adapted to cause a displacement of the toggle, which is adapted to actuate the toggle valve to reset the PRSD.

16. The PRSD of claim 15 wherein, with respect to each resetting mechanism, the corresponding piston rod is adapted to change directions in response to vibration forces such that the PRSD is adapted to be reset each time the piston rod changes direction.

17. The PRSD of claim 15 wherein, with respect to each resetting mechanism, the first disc and the second disc are in toothed engagement.

18. The PRSD of claim 15 wherein, with respect to each resetting mechanism, the first disc and the second disc are in frictional engagement.

19. The PRSD of claim 15 wherein, with respect to each resetting mechanism, the first disc has a smaller diameter than the second disk.

20. The PRSD of claim 19 wherein, with respect to each resetting mechanism:
the first disc is fixed to a first shaft between a first pair of disks of the plurality of disks, each of the first pair of disks having a larger diameter than the first disk, such that the first disk and the first pair of disks are adapted to rotate as a unit; and
the second disk is fixed to a second shaft between a second pair of disks of the plurality of disks that are engaged by the first pair of disks, each of the second pair of disks having a smaller diameter than the second disk, such that the second disk and the second pair of disks are adapted to rotate as a unit;
whereby the second disk and the second pair of disks are adapted to be caused to collectively rotate upon collective rotation of the first disk and the first pair of disks.
